(19) United States
(12) Patent Application Publication
(10) Pub. No.: US 2026/0254306 A1
(43) Pub. Date: Aug. 27, 2026

(54) ELECTRIC MACHINE COMPRISING A ONE-PIECE INTERCONNECTION DEVICE, AND METHOD FOR MOUNTING THE ELECTRIC MACHINE

(71) Applicant: ZF FRIEDRICHSHAFEN AG, Friedrichshafen (DE)

(72) Inventors: Sebastian BAUMGART, Bad Bocklet (DE); Tobias SCHRENK, Bad Neustadt an der Saale (DE); Marcel WERNER, Schonungen (DE); Martin BOTSCH, Schweinfurt (DE); Andreas HESLER, Sennfeld (DE); Christoph WIEDER, Küps (DE); Katja WILLACKER, Prichsenstadt (DE); Roland LINDWURM, Sennfeld (DE)

(21) Appl. No.: 19/163,199

(22) PCT Filed: Mar. 11, 2024
(86) PCT No.: PCT/EP2024/056401

§ 371 Date: Sep. 8, 2025

(30) Foreign Application Priority Data
Mar. 16, 2023 (DE) 10 2023 202 363.6

(51) Int. Cl. H02K 3/50; H02K 15/33

(52) U.S. Cl. CPC H02K 3/50; H02K 15/33; H02K 2203/09

(57) ABSTRACT

An electric machine has a stator, a stator body, and a polyphase stator winding with a winding end per phase, the stator defining a stator axis; a housing divided into a stator body receiving region such that it is fixed with respect to relative rotation, and a connection region for electrically connecting the stator winding; an interconnection device which has, per phase, at least one busbar for electrically contacting the winding ends with a high-voltage connection and an electrically insulating insulation component via which the busbars are mounted at the housing. The insulation component part has, for each busbar one fixing portions for fixing the busbars correctly at the insulation component part and a positioning portion for correctly positioning the winding ends at the busbars, the fixing portions and the positioning portions formed from a common material portion.

### CROSS REFERENCE TO RELATED APPLICATIONS

This is a U.S. national stage of Application No. PCT/EP2024/056401 filed Mar. 11, 2024. Priority is claimed on German Application No. DE 10 2023 202 363.6 filed Mar. 16, 2023, the contents of which are incorporated herein by reference.

### BACKGROUND OF THE INVENTION

### 1. Field of the Invention

The disclosure is directed to an electric machine and a method for assembling the electric machine.

### 2. Description of the Related Art

Electric machines in which a stator winding of a stator is contacted with a high-voltage connection, e.g., power electronics, by an interconnection arrangement in order to apply voltage to the individual phases of the stator winding are known. Due to installation space limitations, it is known from the prior art to arrange the interconnection arrangement outside of a housing of the electric machine rather than inside of the housing. For example, the interconnection arrangement can be axially fastened to a side of the housing remote of the stator.

Publication DE 10 2019 133 674 A1 discloses an electric machine comprising a rotor and a stator. The stator comprises a stator body which carries at least one respective winding of at least one phase. The winding of the respective phase, or at least one of the windings of the respective phase, is conductively connected to a respective contact bridge which connects the respective winding to an associated current source and/or current sink. The respective winding and the contact bridge connected thereto end, respectively, in a conductor portion which extends in axial direction of the electric machine away from the stator body, these conductor portions being conductively connected to one another. A fastening portion of the respective contact bridge is arranged stationary with respect to a housing receiving the stator in that it is fastened via an insulating element or directly to the housing itself on the one hand and/or, on the other hand, to the current source and/or current sink which is in turn fastened to the housing.

### SUMMARY OF THE INVENTION

It is the object of one aspect of the invention to provide an electric machine of the type mentioned above which is characterized by a simple and a cost-effective production of the interconnection device. It is a further object of one aspect of the invention to suggest a corresponding method for assembling the electric machine.

One aspect of the invention is an electric machine which is formed and/or suitable particularly to generate an electric drive torque of a vehicle, preferably a traction torque. For example, the electric machine is formed as a traction machine, as it is called. The electric machine can be integrated in an electric drivetrain, preferably an electric axle. The electric drivetrain can be an all-electric drivetrain or a hybrid drivetrain. The electric machine is preferably constructed as an inrunner.

For this purpose, the electric machine has a stator and a rotor which is preferably arranged radially inside of the stator and which defines an axis of rotation. The stator has a stator body and a polyphase stator winding with at least one, or exactly one, winding end per phase. The stator winding is preferably arranged at the stator body of the stator and/or is partially received therein. In particular, the stator winding has exactly three phase windings for contacting power electronics, each phase winding comprising at least one partial strand. Each partial strand is preferably formed by a plurality of plug-in coils. The plug-in coils can have at least one, preferably exactly two, contact points on at least one side via which the plug-in coils are connected to one another pairwise to form the respective partial strand. In particular, the stator body is formed as a toroidal lamination stack. In particular, the stator body has a plurality of slots extending in each instance along a longitudinal axis, each plug-in coil running through at least one, preferably exactly two, slots which are spaced apart in circumferential direction. The stator winding is preferably formed as a hairpin winding or a wave winding. The plug-in coils can be formed as hairpins, I-pins or D-pins. In particular, the rotor substantially comprises a rotor shaft and a rotor body connected to the rotor shaft so as to be fixed with respect to rotation relative to it. The rotor is rotatably mounted relative to the stator via the rotor shaft, the rotor body being arranged radially inside of the stator body. In particular, a stator axis of the stator is defined by the rotational axis of the rotor.

The electric machine has a housing which is divided, particularly in axial direction with respect to the stator axis, into a receiving region for receiving the stator body such that the latter is fixed with respect to relative rotation and a connection region for electrically connecting the stator winding. In principle, the receiving region and the connection region can be spatially separate from one another. However, it is preferable that the receiving region and the connection region spatially communicate with one another.

The electric machine has an interconnection device, which is formed and/or suitable particularly for the interconnection of the partial strands and plug-in coils, respectively. Particularly preferably, the interconnection device is arranged, in axial direction with respect to the stator axis, at a front side of the stator remote of the contact points. The interconnection device has, per phase, at least one, or exactly one, busbar which is formed and/or suitable for electrically contacting the winding ends with a high-voltage connection. In particular, the winding ends are aligned with, and electrically conductively contact, the respective associated busbar in the connection region in axial direction with respect to the stator axis. The busbars are preferably supported at the respective winding ends in radial direction with respect to the stator axis. In other words, the busbars are radially outwardly supported at the winding ends. The winding ends preferably extend parallel with and/or codirectional to the stator axis. In particular, the winding ends protrude in axial direction from a winding head of the stator winding at least at an axial front side. The high-voltage connection is preferably formed, by way of example, as an AC high-voltage connection of power electronics. In this regard, “high voltage” means an AC voltage of greater than 30 V.

The interconnection device has an electrically insulating insulation component part. The busbars are mounted at the housing via the insulation component part. In particular, the busbars are received in or at the insulation component part so as to be electrically insulated from one another. In principle, the busbars can be partially received in the insulation component part. Alternatively or optionally additionally, busbars are partially embedded in the insulation component part. The insulation component part may be produced from any electrically insulating material, preferably plastic. In particular, the busbars are arranged in the insulation component part in such a way that at least the areas of the busbars electrically contacting the winding ends and high-voltage connection, respectively, are exposed.

It is proposed within the framework of the invention that the insulation component part has, for each busbar, at least one, or exactly one, fixing portion in each instance and a positioning portion in each instance for correctly positioning the winding ends at the busbars. The fixing portion and the positioning portion are formed from a common material portion. In other words, the fixing portion and the positioning portion are integrally formed and produced, particularly from a common injection molded plastic. In a particularly preferred manner, the entire insulation component part is formed and integrally produced from exactly one material portion. In particular, the fixing portion serves to captively fix the individual busbars at the insulation component part. The busbars and the insulation component part are preferably connected to one another integrally via the fixing portions, preferably so as to form a common constructional unit. In particular, the positioning portion serves to capture the individual winding ends during mounting of the interconnection device and subsequently align them in exactly one correctly positioned orientation with respect to the respective busbar so that the winding ends abut and/or electrically contact a conductor portion of the respective busbar in an axial end position of the interconnection device. In a particularly preferred manner, the winding ends are guided in a straight line and/or positively guided to the respective conductor portion via the positioning portions.

One aspect of the invention is based on the understanding that the interconnection device must be constructed of multiple parts in particular installation situations depending on the mounting direction, accessibility and distances from the high-voltage connection. The expected tolerances between the winding ends and high-voltage connection cannot be reconciled in solutions involving multiple parts. Further, the winding ends are formed to be axially lengthened for contacting the busbars. As a result, these winding ends are exposed to the vibrations of the drivetrain and, due to dynamic loads on the contact points, can disengage from the connection. This leads to outage of the electric machine.

The advantage consists in that a particularly close-tolerance, simple assembly of the interconnection device is made possible as a result of the integral construction of the insulation component part. Further, because the interconnection device is formed in one piece, a particularly simple handling of the interconnection device is made possible during the mounting process. Further, the insulation component part can be fashioned in one piece, preferably a plastic injection molding, in a particularly cost-effective manner. A further advantage consists in that an improvement in the mechanical properties of the winding ends is achieved, for example, under vibratory load, by the positioning portion, as a result of which the interconnection device is appreciably more robust vis-à-vis dynamic loads. Further, appreciably larger deviations of the winding ends with respect to the final position can be opted for because the winding ends are aligned in any case during assembly by the centering of the positioning device.

In a particular embodiment, it is provided that the busbars are fixed in axial direction and/or in radial direction with respect to the stator axis in a positively engaging and/or frictionally engaging manner at the insulation component part via the respective fixing portion. In particular, the fixing portions can cooperate with a respective fixing receptacle formed at the busbar. In principle, the busbars can be fixed at the insulation component part by the fixing portions at least in axial direction with respect to the stator axis. Optionally, the busbars are fixed at the insulation component part by the fixing portions in radial and/or tangential direction with respect to the stator axis. In principle, the busbars can be detachably fastened to the insulation component part via the fixing portions, e.g., via a snap connection. However, the busbars are preferably nondetachably and permanently fastened to the insulation component part via the fixing portions, e.g., via a rivet connection. Accordingly, a particularly simple and secure fastening of the busbars to the insulation component part is made possible, which makes do without additional fastening components, such as screws, for example.

In one aspect, it is provided that the fixing portions have, in each instance, a heat staking contour. To this end, the fixing portions are formed as plastic bosses which are melted and plastically deformed through the application of force and heat. The busbars are preferably secured to the insulation component part in axial and radial direction with respect to the stator axis via the heat staking contour. In particular, the fixing receptacles are formed as bore holes or passages through which the fixing portions are guided and heat-staked by melting down. A permanent connection can advantageously be ensured between the components by the heat staking. Further, the heat staking can be produced very easily in an automated production by hot deformation of the fixing portions.

In a further aspect, it is provided that the positioning portions have, in each instance, a guide channel via which at least one each of the winding ends is guided in radial direction and/or in tangential direction with respect to the stator axis in a positionally correct manner to the respective associated busbar. In particular, the winding ends are guided in a straight line and/or positively guided in axial direction with respect to the stator axis through the respective guide channel. The winding ends are preferably received in a positively engaging manner in the respective guide channel in radial direction and/or in tangential direction or circumferential direction, respectively. To this end, the guide channels preferably have, in each instance, a constant, particularly rectangular, opening cross section through which the at least one winding end is partially guided. Accordingly, an insulation component part is proposed that ensures a correct positioning of the winding ends relative to the respective busbar. The mounting process, particularly the joining process between the winding ends and respective busbar, is appreciably facilitated in this way.

In a further particular aspect, it is provided that the winding ends are supported in radial direction on the one hand in the respective associated guide channel and, on the other hand, at the respective associated busbar in a frictionally engaging manner. Simply put, the winding ends are clamped in or wedged between the respective busbar and the guide channel in the final position. Optionally additionally, the winding ends are supported at least in a positively engaging manner inside of the guide channel in tangential direction or in circumferential direction, respectively, in the final position of the interconnection device. Accordingly, the winding ends are guided via the guide channel free from play to the respective busbar, which substantially increases the assembly reliability, particularly during the joining process. Further, as a result of the clamping of the winding ends at the interconnection device, the winding ends can be damped against vibrations.

In a further development, it is provided that the positioning portions have, in each instance, at least one, or exactly one, lead-in chamfer via which the winding ends are inserted and/or insertable in correct position in the respective associated guide channel. In particular, during mounting of the interconnection device, the winding ends are aligned in correct position via the lead-in chamfer in radial and/or tangential direction with respect to the stator axis and are inserted or threaded into the respective guide channel. The lead-in chamfer is preferably formed by at least one sloping surface which runs at an inclination at a radially outer side and/or at a radially inner side from the insertion opening in direction of the guide channel and which is formed and/or suitable for positionally correct insertion of the respective winding end in radial direction. Optionally additionally, the lead-in chamfer is formed by at least one further sloping surface which runs at an inclination in circumferential direction from the insertion opening in direction of the guide channel and which is formed and/or suitable for positionally correct insertion of the respective winding end in tangential direction or circumferential direction, respectively. During an assembly, the winding ends can slide along the sloping surface and be aligned radially and/or tangentially in direction of the guide channel at the same time. In a particularly preferable manner, the positioning portions are funnel-shaped and/or have an opening diameter which decreases or converges toward the guide channel. In this way, it can be ensured by the lead-in chamfer that the winding ends can be easily and securely inserted into the respective guide channel. Because of the converging cross-sectional profile, wide positional tolerances of the winding ends can be compensated particularly easily and the winding ends can be captured in a simple manner during an assembly.

In a further aspect, it is provided that the insulation component part has at least one, or exactly one, fastening portion which is formed and/or suitable for fastening the insulation component part to a housing portion of the electric machine. The fastening portion is formed from the common material portion. In particular, the fastening portion serves to receive and/or to guide fateners, the insulation component part being fastened and/or fastenable to an inner side of the housing in a predefined final position via the fateners. To this end, the fastening portion can have a fastening opening via which the fateners are fixed and/or fixable in a positively engaging and/or frictionally engaging manner in a corresponding fastening receptacle of the housing. In a particularly preferred manner, the fateners are formed as a fastening screw, and the fastening receptacle correspondingly has an internal thread for receiving the fastening screw. In principle, the fastening opening can be formed by a through-bore formed in the fastening portion. Alternatively, the fastening opening may also be formed by a separate bushing, sleeve or the like which is captively secured in the fastening portion. Alternatively, the fastening portion may also have the fastening receptacle, the fateners being guided via a fastening opening formed in the housing. To this end, for example, the fastening receptacle may be formed by a threaded bushing, screw nut or the like which is captively secured in the fastening portion. Accordingly, an insulation component part is proposed that is characterized by a cost-effective production and by a particularly secure assembly and fastening of the interconnection device.

In a further development, it is provided that the fastening portion has a support surface via which the insulation component part is supported at the housing in axial direction with respect to the stator axis. In particular, the housing has a, preferably planar, counter-surface via which the insulation component part is supported at least partially, preferably in a planar manner, in axial direction by the support surface. The support surface particularly preferably extends in a radial plane of the stator axis and/or parallel to the counter-surface. In particular, the support surface is arranged adjoining the fastening opening or fastening receptacle. In particular, the support surface is formed by an annular surface running circumferentially around the fastening opening and fastening receptacle, respectively. A final position of the insulation component part is accordingly defined in axial direction by the support surface.

Optionally additionally, the insulation component part can have at least one further support surface via which the insulation component part is supported at the housing in axial direction with respect to the stator axis. The further support surface can be arranged at a further fastening portion or at any location—preferably at a distance from the support surface—at an underside of the insulation component part. Accordingly, a particularly stable fastening of the interconnection device to the housing is ensured by the at least two support surfaces.

In a further aspect, it is provided that the insulation component part has a centering portion which is formed and/or suitable for positionally correct centering of the insulation component part at the housing of the electric machine. The centering portion is formed from the common material portion. In particular, the centering portion serves to form a centering connection via which the insulation component part is centered and/or centerable in correct position at the housing in radial direction and/or tangential direction. The insulation component part and the housing are preferably connected and/or connectable to one another via the at least one centering portion in exactly one individual orientation. Particularly preferably, the interconnection device is mounted at the stator winding within the framework of a stator assembly, and the interconnection device is centered in the final position via the centering portion when the interconnection device is fitted onto the winding ends. In particular, the individual winding ends are aligned in the final position in such a way that the busbars abut and/or contact the respective winding ends. Accordingly, a centering connection is suggested that is implemented in a particularly simple and cost-effective manner and, at the same time, facilitates mounting and centering of the interconnection device.

In a further development, it is provided that the insulation component part is centered at the housing in a final position via the centering portion in radial direction and/or in tangential direction with respect to the stator axis. To this end, the housing preferably has at least one centering receptacle which is formed and/or suitable for receiving the centering portion. In particular, the centering portion is received in the centering receptacle in radial direction and/or in tangential direction or circumferential direction, respectively, with respect to the stator axis in a positively engaging and/or frictionally engaging manner. To this end, the centering portion is insertable in the centering receptacle during assembly in axial direction with respect to the stator axis and received in radial and tangential direction free from play. Optionally, the centering receptacle and/or the centering portion can have an insertion bevel via which the centering portion is inserted into the centering receptacle with increasing axial movement. For example, the centering portion is formed by a centering boss, centering neck, centering pin, or the like, oriented in axial direction. For example, the centering receptacle is formed by an orifice, bore hole, recess or the like inserted in the housing. This ensures a particularly simple and reliable centering of the insulation component part at the housing.

In a further particular aspect, it is provided that the insulation component part has a plurality of supporting portions which are formed and/or suitable for supporting the busbars so as to be fixed with respect to relative rotation, the supporting portions being formed from the common material portion. In particular, the supporting portions serve to hold the busbars in position and/or support the busbars against twisting, preferably against a torque of a screw connection to the high-voltage connection. Further, the supporting portions can ensure a spacing between the busbars in order to prevent air gaps and creepage distances. The supporting portions preferably extend in each instance continuously and/or uninterruptedly between the busbars. The supporting portions are preferably formed by ribs, webs or the like. Accordingly, an interconnection device is proposed that is characterized by a particularly compact construction and cost-effective production.

In a further aspect, it is provided that the busbars have, in each instance, a contact portion for electrically contacting the high-voltage connection and, in each instance, a conductor portion for electrically contacting the winding ends. In particular, the electric machine has power electronics which are mounted at the housing, preferably in radial direction with respect to the stator axis. The power electronics have the high-voltage connection which has one connection contact per phase. The connection contacts can project into the connection region in a radial direction with respect to the stator axis and electrically conductively contact an associated contact portion. To this end, the connection contacts are preferably contacted, preferably detachably, with the respective contact portion in axial direction with respect to the stator axis. To this end, the connection contacts are particularly preferably contacted with the respective associated contact portion via connectors, preferably a connection screw, in each instance. In particular, the contact portions extend substantially in radial direction with respect to the stator axis. For example, the contact portions are formed as outer connection lugs. In particular, the conductor portions extend substantially in axial direction and/or codirectional to the winding ends. In particular, one or more winding ends of a phase can be contacted with one another at a conductor portion in each instance. Particularly preferably, it is provided that the winding ends are bondingly connected to the respective conductor portions. For example, the winding ends can be welded or soldered to the respective conductor portion. For example, the conductor portions are formed as winding connection lugs. According to this aspect, it is provided that the conductor portions are angled at an angle of greater than 90° relative to the contact portions. In particular, “greater than 90°” means that the conductor portions are angled at an angle between 90° and 100°. In other words, the conductor portions are arranged at an angle of more than 0° and/or less than 10° relative to the winding ends. This ensures that there is no play at the upper surface or front side between the winding end and the conductor portion. The conductor portions can accordingly contact the winding ends in a planar manner or by an edge at the upper side.

In a further aspect, it is provided that the housing has a housing base body and at least one bearing shield that together delimit the connection region of the housing. The insulation component part is secured in a final position at the housing base body. In particular, the housing base body and the at least one bearing shield are connected to one another in axial direction with respect to the stator axis. The housing base body can be open on one or both sides, and the bearing shield closes one side of the housing base body. At least the stator body is preferably arranged completely inside of the housing base body in the receiving region and is connected to the housing base body so as to be fixed with respect to rotation relative to it. Particularly preferably, the rotor shaft is guided through the stator body and rotatably mounted at the bearing shield at the end on one side. On the other side, the rotor shaft can be rotatably mounted at the housing base body or at a further bearing shield. The bearing shield particularly preferably has an assembly opening, particularly an assembly window, via which the interconnection device can be subsequently mounted or removed after the bearing shield has been mounted at the housing base body. Accordingly, an interconnection device is proposed that is characterized by a particularly simple assembly. Further, the stator can be mounted in a simple manner in the housing without the interconnection device.

In a further aspect, it is provided that the insulation component part is centered at the housing base body in axial direction via the fastening portion and centered in correct position at the housing base body via the centering portion in radial and/or tangential direction with respect to the stator axis. In principle, the insulation component part is fastened to the housing base body in a positively engaging manner, particularly via the centering portion, and/or in a frictionally engaging manner, particularly via the at least one fatener.

Alternatively, the insulation component part can also be fastened to the bearing shield in a positively engaging manner, particularly via the centering portion, and/or in a frictionally engaging manner, particularly via the at least one fatener. Accordingly, a simple and secure fastening of the insulation component part in the connection region is suggested.

A further aspect of the invention relates to a method for the assembly of the electric machine, as was previously described, in which: the stator is mounted in the housing, particularly the housing base body; the interconnection device is mounted at the winding ends, and the insulation component part is mounted in a final position at the housing; an axial excess length of the winding ends relative to the busbars is shortened; the winding ends of the interconnection device are electrically conductively connected to the associated busbars, particularly the conductor portions.

In particular, the stator is mounted in the housing base body and subsequently provided as pre-mounted constructional unit. Subsequently, the interconnection device can be fitted onto the winding ends in axial direction with respect to the stator axis and, when fitting on, the winding ends are aligned in correct position with respect to the respective associated busbars, particularly the conductor portions, by the positioning portion. To this end, the interconnection device must be guided radially inward or outward in order to find the positions of the winding ends via the lead-in chamfer. Subsequently, the interconnection device can be aligned in the final position relative to the stator in axial, radial and tangential direction with respect to the stator axis. In so doing, the interconnection device is aligned in the final position via the fastening portion and the centering portion during or after mounting at the winding ends and fastened to the housing base body. The centering connection is preferably produced when fitting the interconnection device, and the fateners are mounted subsequently. After determining the final position, the protruding winding ends are shortened flush with the busbars. In this respect, the interconnection device preferably serves as a cutting-to-length aid. Within the framework of a joining process, the winding ends are bondingly connected to the busbars, preferably the conductor portions, preferably by laser gas welding or tungsten inert gas (TIG) welding. To this end, the interconnection device is preferably held in the final position during the joining process via the fastening portion and the centering portion.

In a further, optional, assembly step, the housing is closed in the course of a rotor assembly. To this end, the rotor and the bearing shield can be assembled in two consecutive assembly steps in principle. To this end, the rotor is inserted into the housing base body coaxial to the stator and the bearing shield is mounted subsequently. Alternatively, however, the rotor and the bearing shield can also be mounted in one assembly step as a combined constructional unit. To this end, the rotor is pre-mounted at the bearing shield and subsequently inserted along with the bearing shield into the housing base body coaxial to the stator.

### BRIEF DESCRIPTION OF THE DRAWINGS

The present invention will be further described in the following referring to the drawings. The drawings show:

FIG. 1 is an electric machine in a sectional view along a stator axis;

FIG. 2 is an axial top view of the electric machine from FIG. 1 without connection cover;

FIG. 3 is a perspective view of an underside of an interconnection device of the electric machine from FIG. 1;

FIG. 4 is an axial top view of a top side of the interconnection device from FIG. 3;

FIG. 5 is a sectional view of the interconnection device from FIG. 3 in an assembly situation;

FIG. 6 is the interconnection device in the same view as FIG. 5 in a final position; and

FIG. 7 is a detail of the busbars and conductor portions.

### DETAILED DESCRIPTION OF THE PRESENTLY PREFERRED EMBODIMENTS

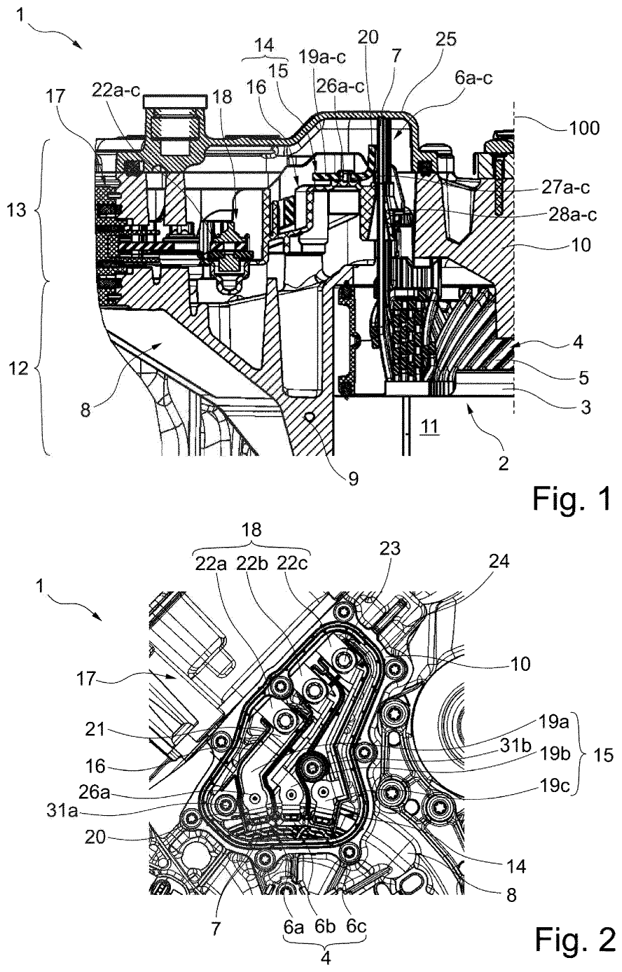

FIG. 1 shows an electric machine 1 which serves to generate an electric drive torque, particularly a traction torque, for an electric axle of a vehicle. The electric machine 1 is formed as an inrunner and has a stator 2 and a rotor, not shown, which is arranged radially inside of the stator 2.

The stator 2 is substantially formed of a stator body 3 and a polyphase stator winding 4. The stator body 3 supports the stator winding 4. To this end, the stator body 3 has a plurality of slots which are distributed in circumferential direction and extend in axial direction with respect to the stator axis 100.

The stator winding 4 is formed by a plurality of plug-in coils 5, for example, in the form of hairpins or I-pins, which are interconnected in a particular pattern. The plug-in coils 5 are arranged in the slots, a plurality of plug-in coils 5 being arranged in each slot. The stator winding 4 has exactly 3 phase windings 6a, 6b, 6c as is shown in FIG. 2. The phase windings 6a, 6b, 6c comprise, in each instance, two partial strands, each with a winding end 7. The winding ends 7 extend parallel and/or codirectional to one another in axial direction with respect to a stator axis 100.

The electric machine 1 has a housing 8. The stator 2 and the rotor are arranged coaxially in the housing 8 with respect to a stator axis 100. The stator axis 100 is defined by a rotational axis of the rotor. The housing 8 has a housing base body 9 and a bearing shield 10 which are connected to one another in axial direction with respect to the stator axis 100. The housing base body 9 and the bearing shield 10 delimit an interior space 11 of the housing 8 which is divided in axial direction with respect to the stator axis 100 into a receiving region 12 and a connection region 13.

The receiving region 12 serves to receive the stator 2 and rotor. The stator 2 and stator body 3, respectively, are connected to the housing base body 9 so as to be fixed with respect to rotation relative to it inside of the receiving region 12. The rotor shaft can be guided through the interior space 11 in axial direction with respect to the stator axis 100 and rotatably mounted at the housing base body 9 on the one hand and at the bearing shield 10 on the other hand.

The connection region 13 serves for the electrical connection of the stator winding 4. To this end, an interconnection device 14 is arranged inside of the connection region 13. The interconnection device 14 serves to connect the winding ends 7. The interconnection device 14 is formed substantially of a connection unit 15 and an insulation component part 16. The winding ends 7 of the individual phase windings 6a, 6b, 6c extend in axial direction with respect to the stator axis 100 in the connection region 13 and are contacted with the connection unit 15.

The electric machine 1 has power electronics 17, only partially shown, which are mounted in radial direction with respect to the stator axis 100 at an outer side of the housing 8, preferably of the housing base body 9, and electrically connected to the stator winding 4 via the interconnection device 14 and, per phase, to the phase windings 6a, 6b, 6c. To this end, the interconnection device 14 is electrically conductively connected via the connection unit 15 to the winding ends 7 of the phase windings 6a, 6b, 6c on the one hand and to a high-voltage connection 18 of the power electronics 17 on the other hand.

As is illustrated in FIG. 2, the connection unit 15 has, in each instance, a busbar 19a, 19b, 19c for each phase winding 6a, 6b, 6c, respectively. The winding ends 7 are electrically conductively connected, per phase, to one of the busbars 19a, 19b, 19c in each instance in order to connect the phase windings 6a, 6b, 6c. In other words, a busbar 19a, 19b, 19c is electrically conductively connected in each instance to the winding ends 7, 8 of a phase winding 6a, 6b, 6c.

To this end, the busbars 19a, 19b, 19c have, in each instance, a conductor portion 20 via which the busbars 19a, 19b, 19c are contacted with the winding ends 7 in radial direction with respect to the stator axis 100. The conductor portions 20 are formed in each instance as winding connection lugs which extend substantially in axial direction with respect to the stator axis 100 and codirectionally with respect to the respective winding ends 7. The interconnection device 14 is arranged outwardly of the winding ends 7 in radial direction with respect to the stator axis 100 and is radially supported at the respective winding ends 7 via the conductor portions 20. For example, the winding ends 7 can be permanently bondingly connected, preferably by a weld connection, to the respective associated conductor portions 20.

Further, the busbars 19a, 19b, 19c have, in each instance, a contact portion 21 per phase winding 6a, 6b, 6c for electrically connecting to the high-voltage connection 18 of the power electronics 17. The high-voltage connection 18 of the power electronics 17 has one connection contact 22a, 22b, 22c per phase which are formed for electrically contacting the contact portions 21 of the busbars 19a, 19b, 19c. In a mounted state of the power electronics 17, the connection contact 22a, 22b, 22c project into the connection region 13, and the connection contacts 22a, 22b, 22c are electrically conductively contacted per phase with the respective contact portion 21 in axial direction with respect to the stator axis 100. The contact portions 21 are formed, respectively, as outer connection lugs, these outer connection lugs extending in a radial direction with respect to the stator axis 100 or in a radial plane of the stator axis 100.

The connection contacts 22a, 22b, 22c are connected to the respective associated contact portion 21 of the busbars 19a, 19b, 19c via connector 23 in each instance. For example, the connectors 23 are formed as a connection screw.

The bearing shield 10 has a connection opening 24 via which the connection region 13 is accessible from the outside. The connection opening 24 is formed as a passage which is dimensioned in such a way that the interconnection device 14 can be mounted or dismounted via the connection opening 24 after the bearing shield 10 has already been mounted. In a final assembly state, the connection opening 24 is closed by a connection cover 25, as is shown in FIG. 1, so as to touchproof the high-voltage connection 18.

As is shown in FIGS. 1 and 2, the insulation component part 16 has a fixing portion 26a, 26b, 26c for each busbar 19a, 19b, 19c serving to fix the respective busbars 19a, 19b, 19c to the insulation component part 16. The busbars 19a, 19b, 19c have, in each instance, a fixing receptacle 27a, 27b, 27c serving to receive the respective fixing portion 26a, 26b, 26c. The fixing portions 26a, 26b, 26c are each formed by a plastic boss which is oriented in axial direction with respect to the stator axis 100 and which is guided through the respective associated fixing receptacle 27a, 27b, 27c and formed into a heat staking contour by melting down. The busbars 19a, 19b, 19c are fixed at the insulation component part 16 in a particularly simple and cost-effective manner in this way.

Further, the insulation component part 16 has, per phase winding 6a, 6b, 6c, a positioning portion 28a, 28b, 28c via which every two winding ends 7 of a phase winding 6a, 6b, 6c are captured and guided to the respective associated conductor portion 20 so as to be correctly positioned. For this purpose, the winding ends 7 are axially lengthened in the connection region 13 for contacting the interconnection device 14. They are accordingly exposed to the vibrations of the drivetrain and may disengage due to dynamic loads at the contact points of the respective conductor portions 20, which leads to outage of the electric machine. The winding ends 7 are protected against the effects of vibrations of the drivetrain and, therefore, against possibly detaching at the contact points by the positioning portion 28. To this end, the winding ends 7 are supported and clamped in, at least in radial direction, at the respective associated conductor portion 20 on the one hand and in the positioning portion 28a, 28b, 28c on the other hand.

The insulation component part 16 is produced from an electrically insulating material, such as plastic, for example, and the fixing portion 26a, 26b, 26c and positioning portion 28a, 28b, 28c are formed from a common material portion and integrally connected to one another. Accordingly, for one, a particularly cost-effective production of the insulation component part 16 is realized and, for another, a low-tolerance, vibration-damped connection is made possible between the high-voltage connection 18 and the stator winding 4.

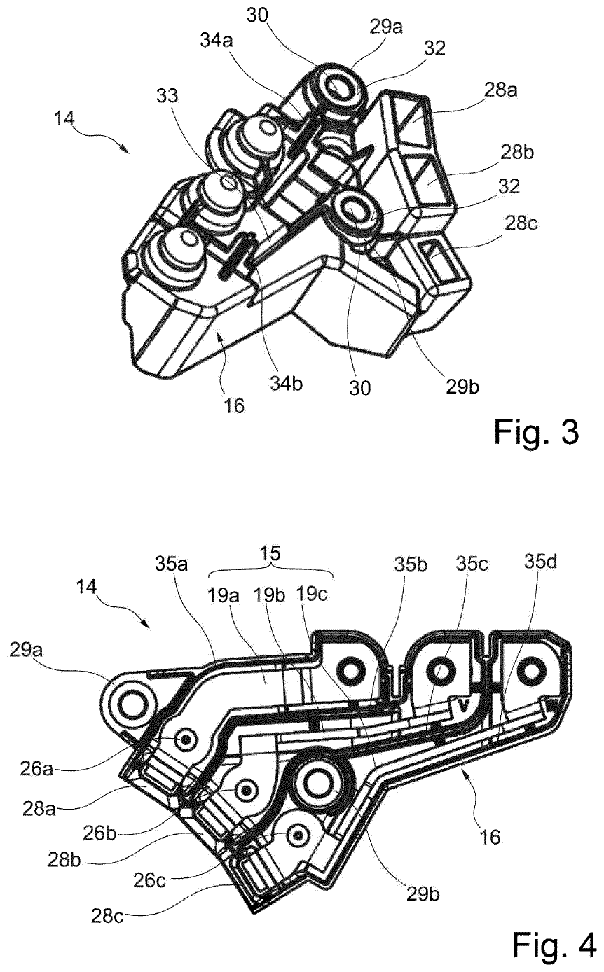

As is shown in FIG. 3, the insulation component part 16 has two fastening portions 29a, 29b which are spaced apart from one another and via which the insulation component part 16 is fastenable to the housing base body 9. The two fastening portions 29a, 29b form, in each instance, a fastening opening 30 via which fateners 31a, 31b are guided in each instance as is shown in FIG. 2 and mounted in a fastening receptacle, not shown, formed in the housing base body 9. For example, the fateners 31a, 31b are formed as fastening screws, in which case the fastening receptacles may be formed as corresponding threaded bore holes. The fastening openings 30 are formed in each instance as through-bores which are aligned correctly positioned in a final position of the interconnection device 14 so as to be flush with and/or in register with the fastening receptacles. The fastening openings 30 may be introduced directly into the fastening portions 29a, 29b or formed through a bushing which is arranged in the respective fastening portion 29a, 29b so as to be fixed with respect to rotation relative to it.

The fastening portions 29a, 29b have, in each instance, a planar support surface 32 via which the insulation component part 16 is supported at the housing base body 9 in axial direction with respect to the stator axis 100. The support surfaces 29a, 29b are formed by an annular surface surrounding the periphery of the fastening opening 30 and extend in a radial plane of the stator axis 100. Further, the insulation component part 16 can have at least one further support surface 33, which is formed at an underside of the insulation component part 16 so as to be spaced from the two support surfaces 33. This makes possible a particularly stable contact of the insulation component part 16 at the housing base body 9.

Further, the insulation component part 16 has two centering portions 34a, 34b which are spaced apart and serve to center the interconnection device 14 in a final position at the housing base body 9. To this end, the two centering portions 34a, 34b are received in a positively engaging manner in a centering receptacle, not shown, formed at the housing base body 9 in a correctly positioned final position in radial and/or tangential direction with respect to the stator axis 100. The centering portion 34a, 34b is formed in each instance as a cross-shaped centering boss which is oriented in axial direction with respect to the stator axis 100 and is directly formed at the underside of the insulation component part 16.

As is illustrated in FIG. 4, the insulation component part 16 has a plurality of supporting portions 35a, 35c, 35b, 35d which extend between the busbars 19a, 19b, 19c. The supporting portions 35a, 35b, 35c, 35d serve on the one hand to prevent twisting of the busbars 19a, 19b, 19c so that a torque of the connector 23 is supported when the screw connection is produced when connecting to the high-voltage connection 18. Further, the supporting portions 35a, 35b, 35c, 35d serve to prevent air gaps and creepage distances between the busbars 19a, 19b, 19c and to electrically insulate the busbars 19a, 19b, 19c from one another. The supporting portions 35a, 35b, 35c, 35d are formed in each instance as a spacer rib, each of which spacer ribs is oriented in axial direction with respect to the stator axis 100 and formed directly at a top side of the insulation component part 16.

The fastening portions 29a, 29b and the supporting portions 35a, 35b, 35c, 35d are formed, together with the fixing portions 26a, 26b, 26c and the positioning portions 28a, 28b, 28c, from the common material portion. Accordingly, an insulation component part 16 is suggested that can be produced in a simple and cost-effective manner in one piece, e.g., by plastics injection molding.

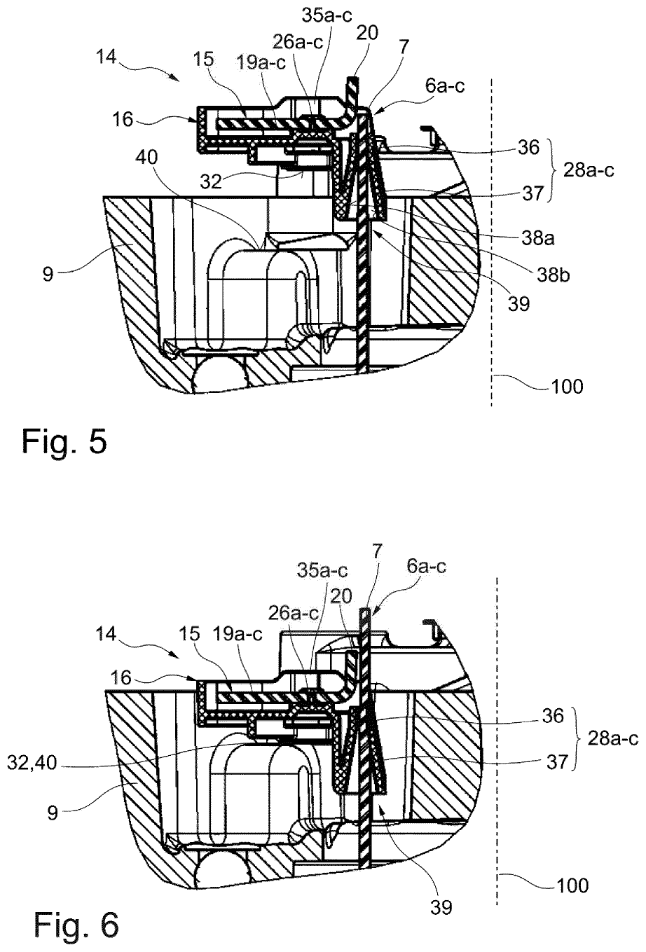

As is illustrated in FIGS. 5 and 6, the positioning portions 28a, 28b, 28c have, in each instance, a guide channel 36 through which the winding ends 7, 8 are guided in a straight line in axial direction with respect to the stator axis 100. The winding ends 7 are partially supported inside of the guide channel 36 in radial direction and in tangential direction or circumferential direction, respectively, with respect to the stator axis 100 in a positively engaging manner.

Further, the positioning portions 28a, 28b, 28c have, in each instance, on the side facing the winding head a lead-in chamfer 37 which serves as an insertion aid for inserting the winding ends 7 in the respective associated guide channel 36 when mounting the interconnection device 14. The winding ends 7 can undergo a change of position via the lead-in chamfer 37 and can therefore be exactly aligned to the connection points of the interconnection device 14. In so doing, manufacturing tolerances of the winding ends 7 are also compensated.

The lead-in chamfers 37 are formed by a sloping surface 38a, 38b in each instance, each sloping surface 38a, 38b extending with a constant pitch angle in direction of the respective guide channel 36 proceeding from the insertion opening 39. The sloping surfaces 38a, 38b are arranged opposite one another in radial direction with respect to the stator axis 100 and accordingly serve for the insertion of the winding ends 7 in a correctly positioned manner. Optionally, the lead-in chamfers 37 can have two further sloping surfaces opposite one another in circumferential direction which serve for the insertion of the winding ends 7 in a correctly positioned manner in circumferential direction or tangential direction, respectively. As a result of the funnel shape produced in this way, the winding ends 7 can be captured in a simple manner and aligned in a correctly positioned manner with respect to the respective conductor portion 20 during mounting of the interconnection device 14.

A method for the assembly of the electric machine 1 will be described in the following referring to FIGS. 5 and 6. The stator 2, as previously described referring to FIG. 1, is mounted in the housing base body 9, particularly in the receiving region 12, without the interconnection device 14. For this purpose, for example, the stator 2 is pressed or joined to dimensions or to the maximum in the housing base body 9.

In a first assembly step, as is illustrated in FIG. 5, the pre-mounted interconnection device 14 is fitted to the winding ends 7. The winding ends 7 are guided via the respective insertion opening 39 and slide along the sloping surfaces 38a, 38b in direction of the guide channel 36. To this end, the interconnection device 14 must be guided radially inward or outward in order to capture the winding ends 7 via the lead-in chamfers 37. Subsequently, the interconnection device 14 can be fitted to the winding ends 7 in axial direction or axially displaced. The winding ends 7 occupy a position in which they are aligned with the conductor portions 20 in a correctly positioned manner.

The interconnection device 14 is fitted onto the winding ends 7 until the insulation component part 16 contacts a counter-surface 40 of the housing base body 9 in axial direction with the support surfaces 32, 33 as shown in FIG. 6. The interconnection device 14 is centered in radial direction and tangential direction with respect to the stator axis 100 in the final position at the same time by the centering portions 34a, 34b. As a result, the insulation component part 16 and the winding ends 6, 8 received therein undergo a change in position which brings about a definite clamping of the winding ends 7 in the guide channels 36. As result of the clamping produced in this way, the mechanical properties, such as vibratory load, can be improved.

Subsequently, the interconnection device 14 can be secured in axial direction by fitting the fateners 31a, 31b. In this way, the interconnection device 14 is secured in the ideal installation position during the further assembly process. In the final position of the interconnection device 14, the winding ends 7 have an axial excess length or overlength relative to the conductor portions 20, which is shortened to the height of the conductor portions 20 and flush with the conductor portions 20 after the insulation component part 16 has been secured to the housing base body 9. Accordingly, axial tolerances between the interconnection device 14 and stator 2 can be compensated in a simple manner.

In a further assembly step, the conductor portions 20 can subsequently be welded to the respective associated winding ends 7 within the framework of a joining process, e.g., by laser welding or TIG welding. The welding process takes place in the housing 8 and in the connection region 12.

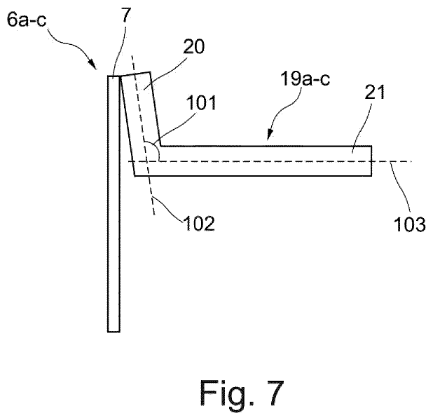

As is shown schematically in FIG. 7, the conductor portions 20 are angled relative to the contact portions 21 at an angle 101 of greater than 90°, e.g., between 92° and 95°. For example, the conductor portions 20 and the contact portions 21 extend in two different component planes 102, 103, the angle 101 being formed therebetween. In other words, the conductor portions 20 are not parallel to the winding ends 7 in the final position of the interconnection device 14 but, rather, contact the upper side with an edge at the winding ends 7. Accordingly, it is ensured that there is no gap at the upper side between the winding ends 7 and the conductor portions 20.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. An electric machine, comprising:
a stator which has a stator body and a polyphase stator winding with at least one winding end per phase, wherein the stator defines a stator axis;
a housing divided into a receiving region that receives the stator body such that the stator body is fixed with respect to relative rotation, and a connection region configured to electrically connect the stator winding; and
an interconnection device which has, per phase, at least one busbar configured to electrically contacting the winding ends with a high-voltage connection and an electrically insulating insulation component part via which the busbars are mounted at the housing,
wherein the insulation component part has, for each busbar:
at least one fixing portion in each instance configured to fix the busbars in a correctly positioned manner at the insulation component part; and
a positioning portion in each instance for correctly positioning the winding ends at the busbars,
wherein the fixing portions and the positioning portions are formed from a common material portion.

17. The electric machine according to claim 16, wherein the busbars are fixed in axial direction and/or in radial direction with respect to the stator axis in a positively engaging and/or frictionally engaging manner at the insulation component part via the respective fixing portion.

18. The electric machine according to claim 17, wherein the fixing portions have, in each instance, a heat staking contour.

19. The electric machine according to claim 16, wherein the positioning portions have, in each instance, a guide channel via which at least one each of the winding ends is guided in radial direction and/or in tangential direction with respect to the stator axis in a positionally correct manner to a respective associated busbar.

20. The electric machine according to claim 19, wherein the winding ends are supported in radial direction in the respective associated guide channel and, at the respective associated busbar in a frictionally engaging manner.

21. The electric machine according to claim 19, wherein the positioning portions have, in each instance, at least one lead-in chamfer via which the winding ends are inserted and/or insertable in correct position in the respective associated guide channel.

22. The electric machine according to claim 16, wherein the insulation component part has at least one fastening portion for fastening the insulation component part to the housing, wherein the fastening portion is formed from the common material portion.

23. The electric machine according to claim 22, wherein the fastening portion has a support surface via which the insulation component part is supported at the housing in axial direction with respect to the stator axis.

24. The electric machine according to claim 16,
wherein the insulation component part has at least one centering portion configured to positionally correct centering of the insulation component part at the housing,
wherein the centering portion is formed from the common material portion.

25. The electric machine according to claim 24, wherein the insulation component part is centered at the housing in a final position via the centering portion in radial direction and/or in tangential direction with respect to the stator axis.

26. The electric machine according to claim 16, wherein the insulation component part has a plurality of supporting portions for supporting the busbars so as to be fixed with respect to relative rotation, wherein the supporting portions are formed from the common material portion.

27. The electric machine according to claim 16,
wherein the busbars have, in each instance, a conductor portion configured to electrically contact the winding ends and have, in each instance, a contact portion configured to electrically contacting the high-voltage connection,
wherein the conductor portions are angled relative to the contact portions at an angle of greater than 90°.

28. The electric machine according to claim 22,
wherein the housing has a housing base body and at least one bearing shield which together delimit the connection region of the housing,
wherein the insulation component part is secured in a final position at the housing base body.

29. The electric machine according to claim 28, wherein the insulation component part is secured in a correctly positioned manner at the housing base body via the at least one fastening portion in axial direction with respect to the stator axis and via a centering portion in radial and/or tangential direction with respect to the stator axis.

30. A method for mounting an electric machine having a stator which has a stator body and a polyphase stator winding with at least one winding end per phase, wherein the stator defines a stator axis; a housing divided into a receiving region that receives the stator body such that the stator body is fixed with respect to relative rotation, and a connection region configured to electrically connect the stator winding; and an interconnection device which has, per phase, at least one busbar configured to electrically contacting the winding ends with a high-voltage connection and an electrically insulating insulation component part via which the busbars are mounted at the housing, wherein the insulation component part has, for each busbar: at least one fixing portion in each instance configured to fix the busbars in a correctly positioned manner at the insulation component part; and a positioning portion in each instance for correctly positioning the winding ends at the busbars, wherein the fixing portions and the positioning portions are formed from a common material portion, comprising:
mounting the stator in the housing;
mounting the interconnection device at the winding ends;
mounting the insulation component part in a final position at the housing;
shortening an axial excess length of the winding ends relative to the busbars; and
electrically conductively connecting the winding ends to an associated busbars.
